(19) United States
(12) Patent Application Publication
(10) Pub. No.: US 2024/0206449 A1
(43) Pub. Date: Jun. 27, 2024

(54) Liquid Distribution Systems for Crop Sprayers, and Related Methods

(71) Applicants: AGCO Corporation, Duluth, GA (US); Precision Planting LLC, Tremont, IL (US)

(72) Inventors: James McGrath Slawson, Spirit Lake, IA (US); Todd Brandon Snyder, Jackson, MN (US); Joseph Paul Anderson, Spirit Lake, IA (US); Justin McMenamy, Edwards, IL (US)

(21) Appl. No.: 18/555,699

(22) PCT Filed: Jan. 5, 2022
(86) PCT No.: PCT/IB2022/050061

§ 371 Date: Oct. 16, 2023

Related U.S. Application Data
(60) Provisional application No. 63/191,131, filed on May 20, 2021.

(51) Int. Cl. A01M 7/00

(52) U.S. Cl. CPC A01M 7/0042; A01M 7/0085

(57) ABSTRACT

A liquid distribution system for a crop sprayer includes a product tank configured to contain a liquid, a pump in fluid communication with the product tank, a plurality of nozzles carried by a boom and configured to receive the liquid from the pump, a recirculation line connecting the plurality of nozzles to the product tank, and a bypass line connecting the pump to the product tank. The recirculation line includes an on/off valve configured to alternatively block or permit flow through the recirculation line. The bypass line includes a second on/off valve configured to alternatively block or permit flow through the bypass line. Related crop sprayers and methods are also disclosed.

### CROSS-REFERENCE TO RELATED APPLICATION

This application claims the benefit of the filing date of U.S. Provisional Patent Application 63/191,131, “Liquid Distribution Systems for Crop Sprayers, and Related Methods,” filed May 20, 2021, the entire disclosure of which is incorporated herein by reference.

### FIELD

Embodiments of the present disclosure relate generally to plumbing for a boom arm on a crop sprayer, and more particularly to liquid distribution system connecting a plurality of spray nozzles along the boom arm to a liquid supply line.

### BACKGROUND

High crop yields of modern agribusiness may require application of fertilizers, pesticides, and/or herbicides. Dispersing these chemicals onto high-acreage fields requires specialized machines mounted on or towed by a vehicle. An example of such a machine is the self-propelled sprayer.

A common design for a self-propelled crop sprayer includes a chassis with a tank, boom arms, and nozzles connected to the boom arms. The tank contains liquid product such as fertilizers, pesticides, and/or herbicides. Boom arms extend outward from the sides of the chassis. Boom plumbing contains supply lines and nozzles spaced apart along the length of the boom arms at a spacing distance corresponding to the spray pattern of the nozzles. In operation, as the crop sprayer crosses the field, liquid is pumped from the tank through the supply lines along the boom arms, and out through the nozzles. This allows the self-propelled sprayer to distribute the liquid along a relatively wide path. The length of conventional boom arms may vary from, for example, 6 meters (18 feet) up to 46 meters (150 feet), but shorter or longer booms are possible. The boom arms typically swing in for on-road transport and out for field-spraying operations.

Conventionally, the nozzles are connected in series such that the product flows through a pipe and/or hose from one nozzle to another. Booms have been of the “wet boom” type, where the boom comprises a frame member with a pipe mounted thereon, where the liquid passes through the pipe into nozzles mounted on the pipe and liquidly connected thereto, or a “dry boom” type, where the nozzles are mounted to the frame member and liquid passes to the nozzles through a hose which is connected between the nozzles. The nozzles are attached to the pipe or frame with brackets at desired intervals along the boom arm.

When a sprayer is first used to dispense a particular product, the product may be flushed through the pipe or hose to each nozzle to fill entire plumbing system with the product. This may help to remove air bubbles and ensure that any prior products are purged from the system. To avoid uneven distribution of the product, this flushing and purging process may be performed before the sprayer enters the planted area of the field. This process may dispense several gallons of product out of the boom to ensure that all of the air is out of the boom and that liquid product can consistently and evenly be dispensed from each of the nozzles.

### BRIEF SUMMARY

In some embodiments, a liquid distribution system for a crop sprayer includes a product tank configured to contain a liquid, a pump in fluid communication with the product tank, a plurality of nozzles carried by a boom and configured to receive the liquid from the pump, a recirculation line connecting the plurality of nozzles to the product tank, and a bypass line connecting the pump to the product tank. The recirculation line includes a first on/off valve configured to alternatively block or permit flow through the recirculation line. The bypass line includes a second on/off valve configured to alternatively block or permit flow through the bypass line.

In further embodiments, a crop sprayer includes a chassis, a product tank carried by the chassis and configured to contain a liquid, a pump in fluid communication with the product tank, a boom supported by the chassis and carrying a plurality of nozzles configured to receive the liquid from the pump, a recirculation line connecting the plurality of nozzles to the product tank, and a bypass line connecting the pump to the product tank. The recirculation line includes a first on/off valve configured to alternatively block or permit flow through the recirculation line. The bypass line includes a second on/off valve configured to alternatively block or permit flow through the bypass line.

Other embodiments include methods of operating a crop sprayer having a pump, a product tank, and a plurality of nozzles spaced along a boom. The methods include circulating a first portion of a liquid through the pump, the nozzles, and a first on/off valve in a recirculation line to the product tank; circulating a second portion of the liquid through the pump and a second on/off valve in a bypass line to the product tank; closing the first on/off valve to terminate flow from the nozzles to the product tank through the recirculation line; closing the second on/off valve to terminate flow from the pump to the product tank through the bypass line; and dispensing liquid from at least some of the plurality of nozzles.

Some embodiments include a method of retrofitting a crop sprayer having a product tank, a plurality of nozzles, and a pump configured to deliver liquid from the product tank to the nozzles. The method includes connecting a recirculation line to at least one nozzle of the plurality of nozzles and to the product tank, the recirculation line comprising a first on/off valve configured to alternatively block or permit flow through the recirculation line; and connecting a bypass line to the pump and to the product tank, the bypass line comprising a second on/off valve configured to alternatively block or permit flow through the bypass line.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 illustrates an agricultural vehicle in the form of a self-propelled crop sprayer;

FIG. 2 illustrates a portion of the agricultural vehicle of FIG. 1 including a boom and part of an application system;

FIG. 3 is a simplified schematic of the application system of the agricultural vehicle of FIG. 1;

FIG. 4 is a simplified schematic view of a nozzle of the application system shown in FIG. 3;

FIG. 5 is a simplified schematic of another application system that may be used in the agricultural vehicle of FIG. 1;

FIG. 6 is a simplified schematic showing another position of a valve in the application system shown in FIG. 5;

FIG. 7 is a simplified schematic of another application system that may be used in the agricultural vehicle of FIG. 1;

FIG. 8 is a simplified top view of another agricultural vehicle, in the form of a crop sprayer towed by a tractor; and

FIG. 9 is a simplified flow chart illustrating a method of operating an agricultural vehicle.

### DETAILED DESCRIPTION

The illustrations presented herein are not actual views of any crop sprayer or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

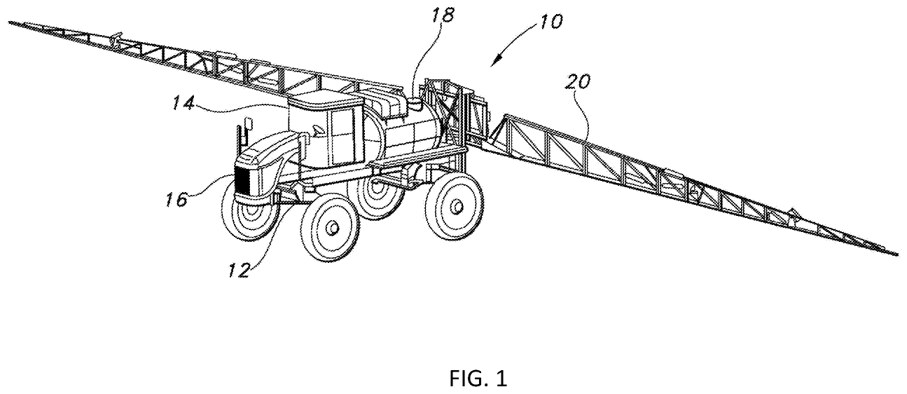

FIG. 1 shows a crop sprayer 10 used to deliver chemicals to agricultural crops in a field. The crop sprayer 10 includes a chassis 12 and an operator cab 14 mounted on the chassis 12. The operator cab 14 may house controls for the crop sprayer 10. An engine 16 may be mounted on a forward portion of chassis 12 in front of operator cab 14 or may be mounted on a rearward portion of the chassis 12 behind the operator cab 14. The engine 16 may be commercially available from a variety of sources and may include, for example, a diesel engine or a gasoline powered internal combustion engine, a battery-powered electric motor, etc. The engine 16 provides energy to propel the crop sprayer 10 through a field on wheels or tracks, and may also provide energy to spray liquids from the crop sprayer 10.

The crop sprayer 10 further includes a product tank 18 to store a liquid to be sprayed on the field. The liquid may include chemicals, such as but not limited to, herbicides, pesticides, and/or fertilizers. The product tank 18 may be mounted on the chassis 12, either in front of or behind the operator cab 14. The crop sprayer 10 may include more than one product tank 18 to store different chemicals to be sprayed on the field. The stored chemicals may be dispersed by the crop sprayer 10 one at a time, or different chemicals may be mixed and dispersed together in a variety of mixtures.

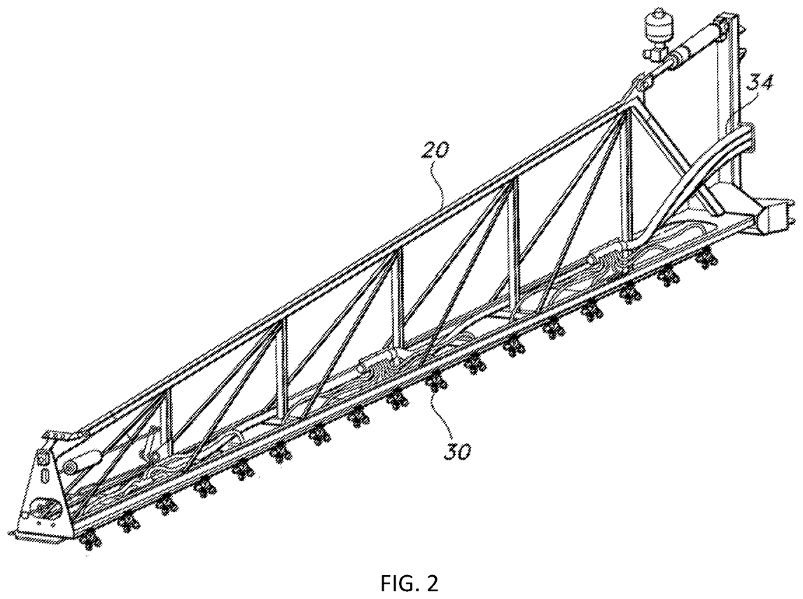

A boom 20 on the crop sprayer 10 is used to distribute the liquid from the product tank 18 over a wide swath as the crop sprayer 10 is driven through the field. The boom 20 may include two or more portions that can fold for transport on public roadways, and unfold (i.e., to the position shown in FIG. 1) for field operations. FIG. 2 is a simplified perspective view of a portion of the boom 20. Liquid is conveyed from the product tank 18 (FIG. 1) by a liquid distribution system 34 to various spray nozzles 30 spaced along the boom 20. The liquid distribution system 34, which may be mounted on the boom arm 20, includes at least one supply line and a recirculation line connected to the product tank 18.

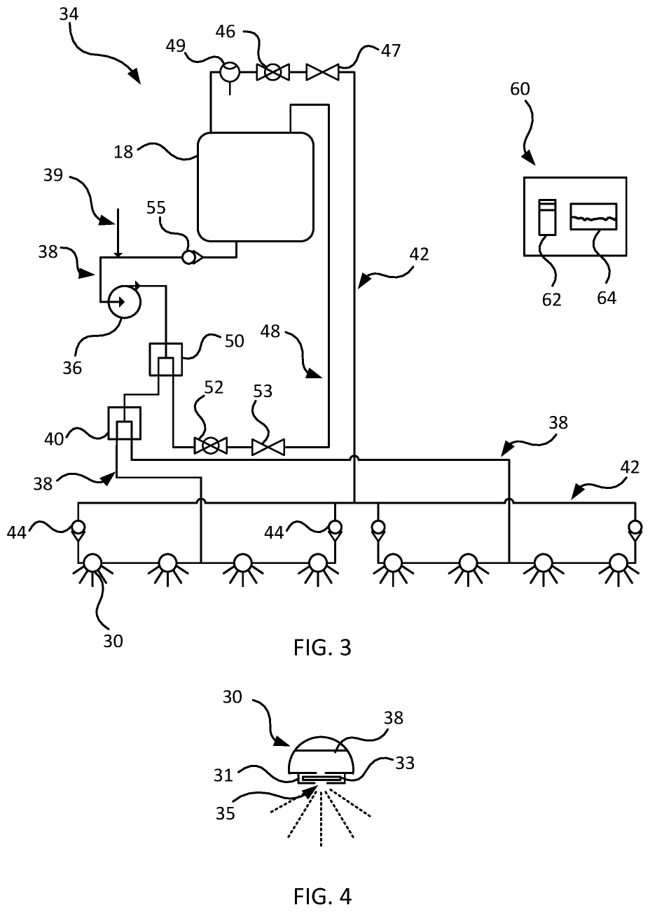

FIG. 3 is a simplified schematic illustrating how the distribution system 34 may be configured. A pump 36 in fluid communication with product tank 18 pumps liquid from the product tank 18 through a supply line 38 to the spray nozzles 30, which are mounted along the boom arm 20 (FIG. 2) at a preselected interval. Each spray nozzle 30 may dispense the liquid onto crops as the crop sprayer 10 is driven through the field.

In some embodiments, the liquid may flow through a manifold 40 in the supply line 38, which may receive the liquid from the pump 36 and distribute the liquid to multiple groups of nozzles 30. For example, and as shown in FIG. 3, the supply line 38 may split into two portions, which each supply groups of nozzles 30 (two groups of four depicted in FIG. 3). It should be understood that the supply line 38 may split into any number of branches, and each branch may supply any number of nozzles 30 independent of other branches. Individual control of different branches of nozzles 30 may be useful for spraying near edges of fields, in irregularly shaped fields, etc.

The distribution system 34 also includes a recirculation line 42 connecting the nozzles 30 back to the product tank 18. One or more check valves 44 may be configured to prevent backflow through the recirculation line 42 from the product tank 18 back to the nozzles 30. That is, the check valves 44 may operate as one-way valves, enabling flow only from the nozzles 30 to the product tank 18. The recirculation line 42 may also include an on/off valve 46 configured to open and close. The on/off valve 46 may be, for example, a gate valve, a ball valve, a needle valve, a butterfly valve, or any other selected valve type. When in an open position, liquid may flow through the supply line 38 (driven by the pump 36), through the check valves 44, through the open on/off valve 46, and back to the product tank 18. The recirculation line 42 may optionally include another valve 47. The valve 47 may be a manually operated valve, which may be closed in case the on/off valve 46 fails. In such a case, the distribution system 34 may still operate to dispense fluid (that is, the valve 47 may be closed to maintain pressure at the nozzles 30). A flow indicator 49 may be in the recirculation line 42 and configured to determine whether there is flow through the recirculation line 42. In some embodiments, the flow indicator 49 may be a flow meter configured to measure the amount of flow. In other embodiments, the flow indicator 49 may simply indicate the presence or absence of flow (i.e., on or off).

FIG. 4 is a simplified schematic view of one of the nozzles 30. As shown, the supply line 38 may go through the nozzle 30. The nozzle may also include a check valve 31 having a diaphragm 33 configured to enable liquid to flow through an orifice 35 in the nozzle body only when the pressure in the supply line 38 exceeds a threshold. Such nozzles 30 are generally used to prevent liquid from dripping from the nozzle 30 when the pump 36 is not operating. When the pump 36 is operating, but pressure in the supply line 38 is below the threshold, the check valve 31 may still prevent flow out of the orifice 35, instead directing all liquid through the nozzle 30 along the supply line 38 to the recirculation line 42.

When liquid can flow in a loop back to the product tank 18 (i.e., in the supply line 38 and the recirculation line 42, because the on/off valve 46 is open), the pressure in the supply line 38 at the nozzles 30 may be maintained lower than the threshold pressure at which the nozzles 30 operate to dispense liquid. That is, if the pressure at the nozzles 30 is relatively low because liquid can flow through the recirculation line 42, the nozzles 30 may not dispense liquid in the field.

The distribution system 34 may also include a bypass line 48 connecting the pump 36 back to the product tank 18 without passing the nozzles 30. A flow splitter 50 may separate flow from the pump 36 such that a portion goes to the nozzles 30 (and, if the on/off valve 46 is open, back through the recirculation line 42), and another portion goes through the bypass line 48. The bypass line 48 may also include an on/off valve 52 configured to open and close. The on/off valve 52 may be, for example, a gate valve, a ball valve, a needle valve, a butterfly valve, or any other selected valve type. When the on/off valve 52 is in an open position, liquid may flow through the flow splitter 50 (driven by the pump 36), through the bypass line 48, and back to the product tank 18. When flow is permitted through the bypass line 48, the pressure in the supply line 38 is decreased. Thus, the pressure in the supply line 38 at the nozzles 30 may be lower than a threshold pressure at which the nozzles 30 operate to dispense liquid. A restriction 53, such as a proportional valve, an orifice, a pressure regulator, or any other device for controlling flow and/or pressure may be in series with on/off valve 52. Though the on/off valve 52 is shown upstream of the restriction 53, the restriction 53 may alternatively be upstream of the on/off valve 52.

Thus, when both the on/off valves 46, 52 are open, liquid may flow in parallel through both the recirculation line 42 and the bypass line 48. The pressure at the nozzles 30 may be kept below the threshold pressure at which the nozzles 30 dispense liquid, and thus, in this mode, the liquid remains in the distribution system 34. This mode can be used to flush or prime the liquid throughout the distribution system 34, removing air bubbles and diluting any residue of liquids used in prior operations. When the on/off valves 46, 52 are closed, the distribution system 34 may be ready to dispense liquid from the nozzles 30 without delay (due to an increase in pressure at the nozzles 30), and without fluctuations in flow that can be caused by air bubbles in the supply line 38.

The restriction 53 in the bypass line 48 controls pressure by limiting flow. For example, if the restriction 53 is set to be relatively more restrictive (i.e., less flow), then pressure in the recirculation line 42 (i.e., the alternate flow path of fluid from the pump 36) may increase.

The valve 47 and restriction 53 may serve as a fail-safe to ensure that the distribution system 34 can be used in the event that one of the on/off valves 46, 52 fails in an open position. If the distribution system 34 did not have the valve 47 or restriction 53, the pressure at the nozzles 30 could be too low for the nozzles 30 to dispense liquid when one or both on/off valves 46, 52 are open. Because the distribution system 34 can still be used if the on/off valves 46, 52 fail in an open position, the on/off valves 46, 52 may be electrically controlled valves configured as normally open (which may be referred to in the art as “fail open,” because without an applied power source, the valve is open). Furthermore, if there is a problem with the control system of the on/off valves 46, 52, and if the valve 47 and restriction 53 are adjustable valves, these adjustable valves may be closed to use the distribution system 34 without recirculation.

In certain embodiments, an air supply line 39 may be connected to the supply line 38, such as between the product tank 18 and the pump 36, as shown in FIG. 3, or between the pump 36 and the flow splitter 50. When a spraying operation is complete, the air supply line 39 may be connected to a source of pressurized air (e.g., a compressor), which may be used to purge the distribution system 34 of liquid by directing the liquid back to the product tank 18. The recirculation line 42 and/or the bypass line 48 may be so purged, depending on the positions of the various valves 46, 52. In particular, the recirculation line 42 may be purged by closing the on/off valve 52 while the on/off valve 46 is open, and the bypass line 48 may be purged by closing the on/off valve 46 while the on/off valve 52 is open. A check valve 55 or sump valve prevents backflow directly into the tank 18. To limit or prevent flow through the nozzles 30 during such a purge, the pressure in the supply line 38 may be maintained below the threshold pressure at which the nozzles 30 operate to dispense liquid, as discussed above.

An operator may control the distribution system 34 via a control environment 60 in the cab of an associated vehicle (e.g., a tractor). The control environment 60 may include, for example, a switch 62 to open and close the on/off valves 46, 52 and a display 64 to provide operator feedback. Though depicted as single switch 62, multiple switches may control the on/off valves 46, 52 separately. The control environment 60 may receive data from the flow meter 49, and may provide, for example, a historical chart and/or an instantaneous reading of the flow through the recirculation line 42. The operator may use such information to determine whether the distribution system 34 is operating as expected. It has been found that direct measurement of the flow in the recirculation line 42 is more useful as an indicator of proper operation of the distribution system 34 than a measurement of pressure in the supply line 38, at the nozzles 30, or elsewhere in the distribution system 34.

In some embodiments, the control environment 60 may be integrated into an existing system of a machine as software. The control environment 60 may optionally include warning lights, sounds, or other indicators. The control environment 60 may communicate with the distribution system 34 by a wired or wireless interface. The control environment 60 may likewise communicate with another device (e.g., a mobile phone, a tablet, the internet, etc.) by a wired or wireless interface, for monitoring and/or control of the distribution system 34.

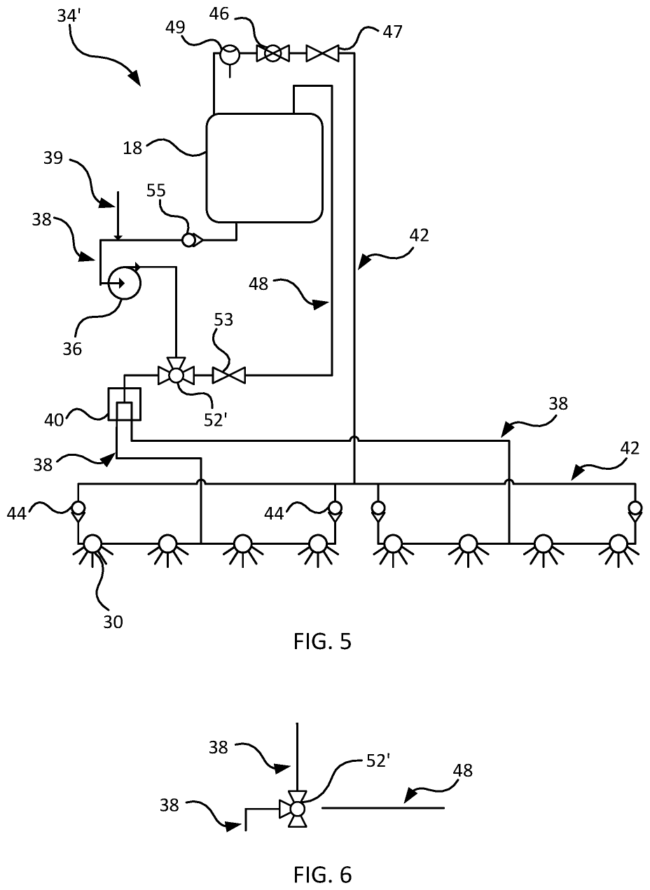

In some embodiments, and as depicted in FIG. 5, a distribution system 34′ may include a valve 52′ in the form of a three-way ball valve, rather than the flow splitter 50 and the on/off valve 52 (FIG. 3). In the position shown in FIG. 5, the valve 52′ directs liquid both to the bypass line 48, and to the nozzles 30 via the supply line 38. FIG. 6 illustrates a portion of the system shown in FIG. 5 including the valve 52′. In the position shown in FIG. 6, the valve 52′ is rotated to direct liquid only to the nozzles 30 via the supply line 38, and the bypass line 48 is blocked.

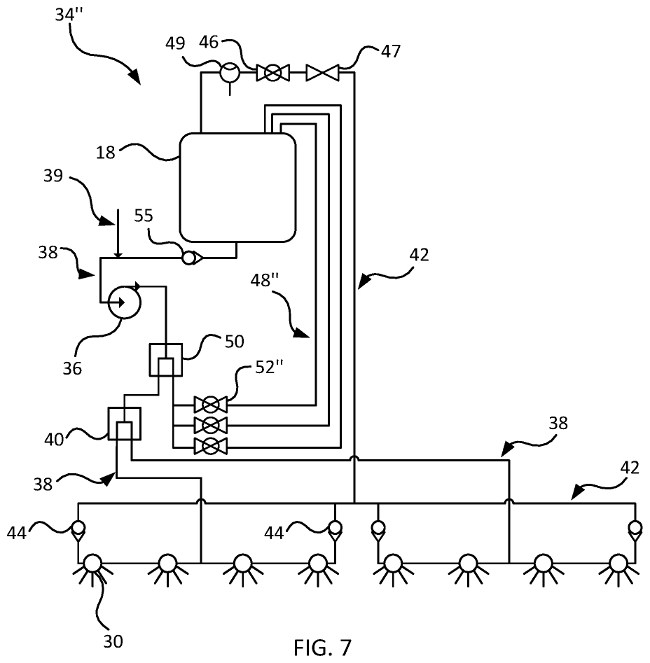

In some embodiments, and as depicted in FIG. 7, a distribution system 34″ may include two or more bypass line 48″ instead of a single bypass line 48. In such, embodiments, the restriction 53 of the bypass line 48 may be omitted. The amount of pressure in and flow through the bypass line(s) 48″ may be controlled by number and identity of the bypass line(s) 48 that are open, which is controlled by on/off valves 52″.

The on/off valves 46, 52, 52′, 52″ may be controlled by an operator of the crop sprayer 10 using controls located in the cab 14 of the crop sprayer 10 (e.g., the control environment 60 shown in FIG. 3). The on/off valves 46, 52, 52′, 52″ may be mechanically, electrically, or pneumatically controlled, for example.

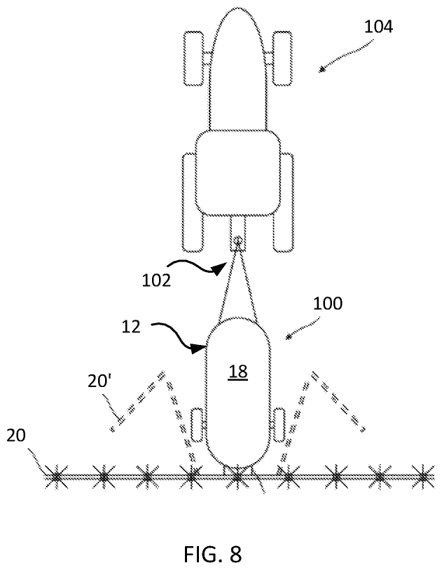

FIG. 8 shows another crop sprayer 100 that may be used to deliver chemicals to agricultural crops in a field. The crop sprayer 100 is a pull-type including a chassis 12 carrying the product tank 18. The crop sprayer 100 has a hitch 102 configured to couple the chassis 12 to a tractor 104. The tractor 104 may therefore pull the crop sprayer 100 through the field, and the operator of the tractor 104 may also operate the crop sprayer 100 via a control system in the cab of the tractor 104. The boom arms 20 may fold for road transport (indicated by boom position 20′).

The liquid distribution system 34 enables recirculation of the liquid back to the product tank 18 in order to prime the supply line 38 and nozzles 30 before spraying operations, without wasting liquid. The recirculation may push any air from the supple line 38 or nozzles 30 back to the product tank 18 in order to spray consistently and accurately.

The liquid distribution system 34 may be used to retrofit an existing crop sprayer, which typically includes the product tank 18, the pump 36, the supply line 38, and the nozzles 30. The supply line 38 of a conventional crop sprayer may be capped at the end of a line of nozzles 30. To retrofit the crop sprayer, the end of each line of nozzles 30 can be uncapped, and the recirculation line 42, and optionally, the check valves 44, are added to each uncapped end to direct the liquid from the nozzles 30 area to the product tank 18. The on/off valve 46 is also added, and may be located near the top of the product tank 18. The on/off valve 52 is installed downstream from the pump 36, which can be opened during priming to divert liquid pressure directly back to the product tank 18 in order to not overpressure the nozzles 30, to avoid causing the nozzles 30 to leak or spray liquid. The valve 47 and restriction 53 can be set to control the pressure and flow through each line 42, 48. Typically, the valve 47 and restriction 53 are set once, and not adjusted during field use (though the valve 47 and restriction 53 may be adjusted as part of maintenance or repair). If an operator decides recirculation is needed to prime the boom with product, both the on/off valves 46, 52 are opened, and the pump 36 is turned on to allow the liquid to flow from the pump 36 through the recirculation line 42 and the bypass line 48. Because the pressure in the nozzles 30 is less than the threshold pressure of the nozzles 30, the liquid simply flows back to the product tank 18. This pushes any air in the supply line 38 back to the product tank 18 and ensures all of the plumbing is full of liquid. When the operator wishes to apply liquid to the ground, the on/off valves 46, 52 are closed, increasing the liquid pressure in the supply line 38 and nozzles 30. This opens the diaphragms 33, allowing the liquid to spray from the nozzles 30 onto the ground.

The check valves 44 have been observed to reduce the time required to stop flow through the nozzles upon opening the on/off valve 52, due to the reduction in back-flow in the recirculation line 42. Another benefit of including the check valves 44 is that different sections of the nozzles 30 (i.e., those in line with each check valve 44) can be controlled separately. However, the liquid distribution system 34 can still operate without the check valves 44.

Another benefit of the distribution system 34 that includes a recirculation line 42 is that there may be no dead ends in the distribution system 34 because liquid can flow in complete loops. Thus, it may be relatively easier to clean the entire distribution system 34 (e.g., by putting clean water in the product tank 18 and operating the pump 36 with the on/off valves 46, 52 open). Keeping the distribution system 34 clean may prolong the life of the components of the distribution system 34. Furthermore, recirculating the liquid when priming the supply line 38 and nozzles 30 may prevent waste of the liquid, and thus, may lead to lower costs of using the crop sprayer 10 as compared to conventional sprayers.

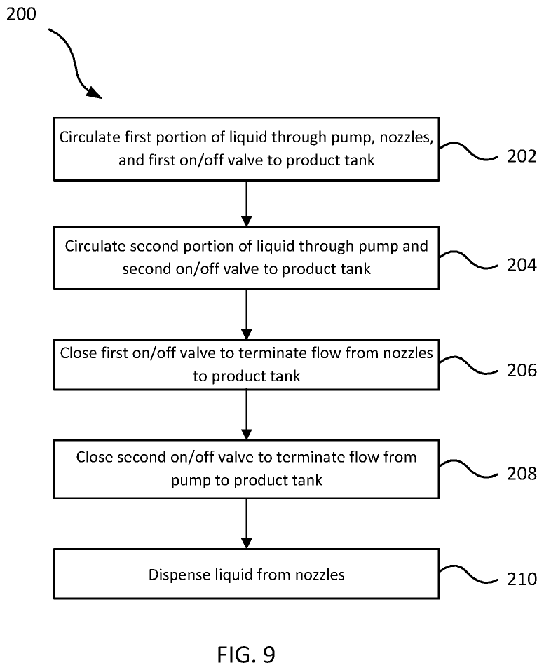

FIG. 9 is a simplified flow chart illustrating a method 200 of operating the crop sprayer 10 (FIG. 1) or the crop sprayer 100 (FIG. 8) in an agricultural field. In block 202, the method includes circulating a first portion of a liquid through the pump, the nozzles, a check valve, and a first on/off valve to the product tank. Recirculation of the liquid may keep the pressure at the nozzles below the threshold pressure at which the nozzles begin to spray.

Block 204 represents circulating a second portion of the liquid through the pump, a restriction, and a second on/off valve to the product tank. Bypassing some of the liquid may keep the pressure at the nozzles below the threshold pressure at which the nozzles begin to spray.

In block 206, the first on/off valve is closed to terminate flow from the check valve to the product tank through the recirculation line.

In block 208, the second on/off valve is closed to terminate flow from the pump to the product tank through the bypass line.

In block 210, liquid is dispensed from at least some of the plurality of nozzles, typically while the spray boom is propelled through an agricultural field. The actions in blocks 206 and 208 may increase the pressure of the liquid at the nozzles, causing the action in block 210.

Though depicted as a flow chart, the actions in FIG. 9 may be performed concurrently (e.g., the actions in blocks 202 and 204 concurrently, followed by the actions in blocks 206 and 208 concurrently), and in some embodiments, some actions may be omitted.

Additional non-limiting example embodiments of the disclosure are described below.

Embodiment 1: A liquid distribution system for a crop sprayer, comprising a product tank configured to contain a liquid, a pump in fluid communication with the product tank, a plurality of nozzles carried by a boom and configured to receive the liquid from the pump, a recirculation line connecting the plurality of nozzles to the product tank, and a bypass line connecting the pump to the product tank. The recirculation line comprises a first on/off valve configured to alternatively block or permit flow through the recirculation line. The bypass line comprises a second on/off valve configured to alternatively block or permit flow through the bypass line.

Embodiment 2: The liquid distribution system of Embodiment 1, further comprising a check valve in the recirculation line, wherein the check valve is configured to prevent flow from the product tank to the plurality of nozzles through the recirculation line.

Embodiment 3: The liquid distribution system of Embodiment 1 or Embodiment 2, further comprising a flow indicator configured to detect flow through the recirculation line.

Embodiment 4: The liquid distribution system of any one of Embodiment 1 through Embodiment 3, wherein the plurality of nozzles comprises a first plurality of nozzles and a second plurality of nozzles, and wherein each plurality of nozzles is configured to receive the liquid from the pump independent of the other plurality of nozzles.

Embodiment 5: The liquid distribution system of Embodiment 4, further comprising a manifold configured to receive the liquid from the pump and distribute the liquid to each of the first plurality of nozzles and the second plurality of nozzles.

Embodiment 6: The liquid distribution system of any one of Embodiment 1 through Embodiment 5, wherein each of the plurality of nozzles comprises a check valve to enable flow through the respective nozzle when a pressure at the respective nozzle exceeds a threshold.

Embodiment 7: The liquid distribution system of any one of Embodiment 1 through Embodiment 6, further comprising a flow splitter in fluid communication with the pump, the nozzles, and the bypass line.

Embodiment 8: The liquid distribution system of Embodiment 7, wherein the flow splitter comprises the second on/off valve.

Embodiment 9: The liquid distribution system of Embodiment 8, wherein the flow splitter is configurable to direct flow from the pump to the plurality of nozzles and the bypass line.

Embodiment 10: The liquid distribution system of any one of Embodiment 1 through Embodiment 9, wherein the bypass line further comprises a restriction in series with the second on/off valve.

Embodiment 11: The liquid distribution system of any one of Embodiment 1 through Embodiment 10, further comprising a control system configured to selectively control positions of the first and second on/off valves, wherein when the first and second on/off valves are in a first position, the pump is configured to circulate the liquid through the recirculation line and the bypass line, and wherein when the first and second on/off valves are in a second position, the pump is configured to pump the liquid out through at least some of the plurality of nozzles.

Embodiment 12: A crop sprayer comprising a chassis, a product tank carried by the chassis and configured to contain a liquid, a pump in fluid communication with the product tank, a boom supported by the chassis and carrying a plurality of nozzles configured to receive the liquid from the pump, a recirculation line connecting the plurality of nozzles to the product tank, and a bypass line connecting the pump to the product tank. The recirculation line comprises a first on/off valve configured to alternatively block or permit flow through the recirculation line. The bypass line comprises a second on/off valve configured to alternatively block or permit flow through the bypass line.

Embodiment 13: The crop sprayer of Embodiment 12, further comprising an engine supported by the chassis, the engine configured to propel the chassis through an agricultural field.

Embodiment 14: The crop sprayer of Embodiment 12 or Embodiment 13, further comprising an operator cab supported by the chassis.

Embodiment 15: The crop sprayer of Embodiment 12, further comprising a hitch configured to couple the chassis to a tractor.

Embodiment 16: A method of operating a crop sprayer comprising a pump, a product tank, and a plurality of nozzles spaced along a boom. The method comprises circulating a first portion of a liquid through the pump, the nozzles, and a first on/off valve in a recirculation line to the product tank; circulating a second portion of the liquid through the pump and a second on/off valve in a bypass line to the product tank; closing the first on/off valve to terminate flow from the check valve to the product tank through the recirculation line; closing the second on/off valve to terminate flow from the pump to the product tank through the bypass line; and dispensing liquid from at least some of the plurality of nozzles.

Embodiment 17: The method of Embodiment 16, wherein closing the first on/off valve and closing the second on/off valve comprises increasing a pressure of the liquid at the nozzles.

Embodiment 18: The method of Embodiment 16 or Embodiment 17, wherein the nozzles are configured to spray only when the liquid is above a threshold pressure, and wherein circulating a first portion of a liquid in a recirculation line comprises maintaining a pressure in the nozzles below the threshold pressure.

Embodiment 19: The method of any one of Embodiment 16 through Embodiment 18, wherein dispensing liquid from at least some of the plurality of nozzles comprises dispensing liquid from the nozzles while propelling the boom through an agricultural field.

Embodiment 20: A method of retrofitting a crop sprayer comprising a product tank, a plurality of nozzles, and a pump configured to deliver liquid from the product tank to the nozzles. The method comprises connecting a recirculation line to at least one nozzle of the plurality of nozzles and to the product tank, the recirculation line comprising a first on/off valve configured to alternatively block or permit flow through the recirculation line; and connecting a bypass line to the pump and to the product tank, the bypass line comprising a second on/off valve configured to alternatively block or permit flow through the bypass line.

Embodiment 21: The method of Embodiment 20, wherein connecting a recirculation line to at least one nozzle of the plurality of nozzles comprises uncapping a supply line connecting a plurality of the nozzles.

Embodiment 22: The method of Embodiment 20 or Embodiment 21, further comprising configuring a control system associated with the crop sprayer to open the first and second on/off valves and operate the pump to prime the nozzles for a spraying operation.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various machine types and configurations.

1. A liquid distribution system for a crop sprayer, comprising:
a product tank configured to contain a liquid;
a pump in fluid communication with the product tank;
a plurality of nozzles carried by a boom and configured to receive the liquid from the pump;
a recirculation line connecting the plurality of nozzles to the product tank, the recirculation line comprising a first on/off valve configured to alternatively block or permit flow through the recirculation line; and
a bypass line connecting the pump to the product tank, the bypass line comprising a second on/off valve configured to alternatively block or permit flow through the bypass line and a third valve in series with the second on/off valve.

2. The liquid distribution system of claim 1, further comprising a check valve in the recirculation line, wherein the check valve is configured to prevent flow from the product tank to the plurality of nozzles through the recirculation line.

3. The liquid distribution system of claim 1, further comprising a flow indicator configured to detect flow through the recirculation line.

4. The liquid distribution system of claim 1, wherein the plurality of nozzles comprises a first plurality of nozzles and a second plurality of nozzles, and wherein each plurality of nozzles is configured to receive the liquid from the pump independent of the other plurality of nozzles.

5. The liquid distribution system of claim 4, further comprising a manifold configured to receive the liquid from the pump and distribute the liquid to each of the first plurality of nozzles and the second plurality of nozzles.

6. The liquid distribution system of claim 1, wherein each of the plurality of nozzles comprises a check valve to enable flow through the respective nozzle when a pressure at the respective nozzle exceeds a threshold.

7. The liquid distribution system of claim 1, further comprising a flow splitter in fluid communication with the pump, the nozzles, and the bypass line.

8. The liquid distribution system of claim 7, wherein the flow splitter comprises the second on/off valve.

9. The liquid distribution system of claim 8, wherein the flow splitter is configurable to direct flow from the pump to the plurality of nozzles and the bypass line.

10. The liquid distribution system of claim 1, wherein the bypass line further comprises a restriction in series with the second on/off valve.

11. The liquid distribution system of claim 1, further comprising a control system configured to selectively control positions of the first and second on/off valves, wherein when the first and second on/off valves are in a first position, the pump is configured to circulate the liquid through the recirculation line and the bypass line, and wherein when the first and second on/off valves are in a second position, the pump is configured to pump the liquid out through at least some of the plurality of nozzles.

12. A crop sprayer, comprising:
a chassis; and
the liquid distribution system of claim 1 carried by the chassis.

13. The crop sprayer of claim 12, further comprising an engine supported by the chassis, the engine configured to propel the chassis through an agricultural field.

14. The crop sprayer of claim 12, further comprising an operator cab supported by the chassis.

15. The crop sprayer of claim 12, further comprising a hitch configured to couple the chassis to a tractor.

16. A method of operating a crop sprayer comprising a pump, a product tank, and a plurality of nozzles spaced along a boom, the method comprising:
circulating a first portion of a liquid through the pump, the nozzles, and a first on/off valve in a recirculation line to the product tank;
circulating a second portion of the liquid through the pump, a second on/off valve, and a third on/off valve in a bypass line to the product tank;
closing the first on/off valve to terminate flow from the nozzles to the product tank through the recirculation line;
closing the second on/off valve to terminate flow from the pump to the product tank through the bypass line; and
dispensing liquid from at least some of the plurality of nozzles.

17. The method of claim 16, wherein closing the first on/off valve and closing the second on/off valve comprises increasing a pressure of the liquid at the nozzles.

18. The method of claim 16, wherein the nozzles are configured to spray only when the liquid is above a threshold pressure, and wherein circulating a first portion of a liquid in a recirculation line comprises maintaining a pressure in the nozzles below the threshold pressure.

19. The method of claim 16, dispensing liquid from at least some of the plurality of nozzles comprises dispensing liquid from the nozzles while propelling the boom through an agricultural field.

20. A method of retrofitting a crop sprayer comprising a product tank, a plurality of nozzles, and a pump configured to deliver liquid from the product tank to the nozzles, the method comprising:
connecting a recirculation line to at least one nozzle of the plurality of nozzles and to the product tank, the recirculation line comprising a first on/off valve configured to alternatively block or permit flow through the recirculation line; and
connecting a bypass line to the pump and to the product tank, the bypass line comprising a second on/off valve configured to alternatively block or permit flow through the bypass line and a third valve in series with the second on/off valve.

21. The method of claim 20, wherein connecting a recirculation line to at least one nozzle of the plurality of nozzles comprises uncapping a supply line connecting a plurality of the nozzles.

22. The method of claim 20, further comprising configuring a control system associated with the crop sprayer to open the first and second on/off valves and operate the pump to prime the nozzles for a spraying operation.
